(19) United States
(12) Patent Application Publication
(10) Pub. No.: US 2010/0223556 A1
(43) Pub. Date: Sep. 2, 2010

(54) OPERATIONAL STATUS DISPLAY SYSTEM FOR ANALYZING APPARATUS

(75) Inventors: Kazuhito Wakabayashi, Kyoto-shi (JP); Ryuji Nishimoto, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: SHIMADZU CORPORATION, Nakagyo-ku, Kyoto (JP)

(21) Appl. No.: 12/161,446

(22) PCT Filed: Jan. 30, 2006
(86) PCT No.: PCT/JP2006/301451

§ 371 Date: Jul. 18, 2008

(51) Int. Cl. G06F 3/048; G06F 15/16

(52) U.S. Cl. 715/736; 715/772; 715/781; 715/808; 715/822; 709/203

(57) ABSTRACT

In an analyzing system including a plurality of analyzing apparatuses and an operational status collector for collecting the analyzing apparatus' operational status by way of a data communication network, each status of the plurality of analyzing apparatuses is conventionally displayed in the form of a list. This causes a problem that there is no knowing the installation position of an actual analyzing apparatus from a client for analysis which is installed separately from the analyzing apparatus. In the operational status display system for an analyzing apparatus according to the present invention, an analyzing apparatus arrangement image is displayed in which the arrangement positions of the analyzing apparatuses are illustrated with apparatus images. The user can easily grasp the actual arrangement position of an analyzing apparatus. Alternatively, each analyzing apparatus' operational status may be displayed on the apparatus image. With this configuration, it is possible to know each analyzing apparatus' operational status. Furthermore, a click of an apparatus image may display a detail setting window, which can smooth the control operation.

### TECHNICAL FIELD

The present invention relates to a system for remotely monitoring an analyzing apparatus such as a liquid chromatograph and mass spectrometer. In particular, the present invention relates to a system for remotely monitoring the operational status of a plurality of apparatuses connected to a network.

### BACKGROUND ART

In a liquid chromatograph, for example, in performing an analysis for a plurality of samples, an analysis schedule in which vial numbers and injection volumes in an auto-sampler are set for example is specified. Then samples are sequentially taken from the auto-sampler in accordance with the schedule to perform an analysis to obtain analysis data. In general, an operator can check the progress of an analysis in accordance with a schedule on the window shown on the display of the analyzing apparatus. In recent years, a personal computer (which will be hereinafter called “PC” using the short form) has often been used as a data processing and/or controlling unit for an analyzing apparatus. With such an apparatus, the progress of an analysis can be checked on the display of the PC connected one-to-one to an analyzer.

In facilities and companies recently using such an analyzing apparatus, a plurality of analyzing apparatuses were installed and often kept in almost constant operation in order to effectively manage each analyzing apparatus. Under such circumstances, there are many demands such as: an operator needs to check the progress of each analyzing apparatus, look for an available analyzing apparatus to perform an analysis, or check the progresses of a plurality of analyses that the operator is in charge of. Conventionally, however, the operator is required to go to the installation location of each analyzing apparatus and check the progress of the analysis in the analyzing apparatus by operating the analyzing apparatus or a PC connected to it. For this reason, in the case where many analyzing apparatuses are installed and their installation locations are separated from each other, it is necessary to check around each analyzing apparatus to know the progresses of all analyzing apparatuses, which is very bothersome and ineffective.

In order to solve such a problem, the applicant of the present application has already suggested the analyzing apparatus and analyzing system described in Patent Document 1. In the analyzing apparatus described in this document, a device-inside analysis progress information collection part collects analysis progress information that indicates the progress of an analysis in the analyzing apparatus, and a device-outside analysis progress information collection part collects analysis progress information that indicates the progress of an analysis in other analyzing apparatus connected to a network through a communication by way of the network. The progress information may include status information of an analysis which is automatically progressed in each analyzing apparatus in accordance with an analysis schedule table in which an analysis procedure is specified. The status information may be, for example, “ready before execution”, “in execution”, “finished”, “error”, or other status information. The progress information may further include information for identifying a person in charge of the analysis, estimated completion time of the analysis and other information. Such analysis progress information in each analyzing apparatus is aggregated by the analyzing apparatus, and then an information integrator integrates these pieces of the analysis progress information to be displayed in a predetermined format, typically in the form of a list. Then a displayer shows the list of such analysis progress information on a display. With this analyzing apparatus, the operator can also check the progress of an analysis in other analyzing apparatus while being in the installation location of this analyzing apparatus. Therefore, for example, it is easily possible to effectively make all the analyzing apparatuses operate by looking for an available analyzing apparatus at the point in time or an analyzing apparatus which will be available before long. In addition, this eliminates the trouble of looking around to check the progress even in the case where each analyzing apparatus is installed in separate locations, which also improves the working efficiency.

In the analyzing system described in Patent Document 1, as with the aforementioned analyzing apparatus, all pieces of analysis progress information are collected into a predetermined analyzing apparatus, and then the analysis progress information is integrated to be displayed in the form of a list or the like. However, the information is sent to a client terminal by way of a network to be displayed on the display window of the client terminal. The client terminal in this system is a personal computer which may have a function for analyzing the analysis data collected by the analyzing apparatus or a function of a database server for storing such data. Therefore, with this analyzing system, the operator can check the progress of the analysis of the entire analyzing apparatuses while being in the installation location of the client terminal.

[Patent Document 1] Japanese Unexamined Patent Application Publication No. 2004-85356

### DISCLOSURE OF THE INVENTION

### Problem to be Solved by the Invention

As described earlier, in the analyzing system described in Patent Document 1, each status of plural analyzing apparatuses is displayed in the form of a list (See FIG. 6 for example). That is, each apparatus is identified only by a unique identification name such as “LC1”, “LC2”, . . . .

In the meantime, after controlling an analyzing apparatus by using a terminal on a network, a user relatively frequently goes to the appropriate analyzing apparatus to set a sample. However, when it is necessary to perform this sort of operation, the actual installation location of the intended analyzing apparatus cannot be known from the list of the analyzing system of Patent Document 1. The user has to remember by memory or refer to an administrative chart separately prepared, which is very inconvenient. The present invention is achieved to solve such a problem, and the aim thereof is to support a user to easily associate, in a system for remotely monitoring an analyzing apparatus connected to a network, the analyzing apparatus to be operated and/or checked on a terminal with an actual analyzing apparatus.

### Means for Solving the Problem

To solve the aforementioned problem, the present invention provides an operational status display system for an analyzing apparatus, including a plurality of analyzing apparatuses and a client for analysis which has an operational status collector for collecting an operational status of an analyzing apparatus through a data communication network, wherein the client for analysis includes:

an image memory for storing an analyzing apparatus arrangement image in which a plurality of mutually-discriminable apparatus images corresponding one-to-one to the analyzing apparatuses are arranged in order to present an actual arrangement position of the analyzing apparatuses.

Preferably, the operational status display system for an analyzing apparatus according to the present invention may further include an operational status image creator for creating, at a predetermined timing, an operational status image in which an operational status of a corresponding analyzing apparatus on each apparatus image is displayed in the analyzing apparatus arrangement image.

Preferably, the client for analysis may further include a setting window displayer for displaying, based on an entry of a predetermined input operation with a specifier being placed on an apparatus image, a setting window for an analyzing apparatus corresponding to the apparatus image in a window for the operational status image.

### Effect of the Invention

With the operational status display system for an analyzing apparatus according to the present invention, an analyzing apparatus arrangement image in which an arrangement position of an analyzing apparatus is presented is displayed on the display of a client for analysis, which is often installed separately from the analyzing apparatus. Therefore, the user can visually recognize the position where the analyzing apparatus is installed. Hence, when the user operates an analyzing apparatus composed of a client terminal, for example, a client terminal and goes to the corresponding analyzing apparatus to set a sample, the user can eliminate troubles such as: the user goes to a wrong analyzing apparatus and the user has to locate its installation location.

In the case where the client for analysis has an operational status image creator, the operational status of each image apparatus is constantly updated and displayed on the operational status image. Therefore, the user can determine the current status of the analyzing apparatus in real time without opening a list which shows the operational status.

In the case where the client for analysis has a setting window displayer, when the user performs an input operation such as a click with a specifier such as a mouse pointer being placed on an apparatus image in the window in which the operational status image is displayed, a setting window for the analyzing apparatus corresponding to the apparatus image is instantly displayed. This leads to a smooth and more intuitive operation.

### BRIEF DESCRIPTION OF THE DRAWINGS

FIG. 1 is a block diagram illustrating a schematic configuration of an embodiment of the operational status display system for an analyzing apparatus according to the present invention.

FIG. 2 is a display example of a window including an operational status image.

FIG. 3 is an example of an operational status image in which a detailed indication is displayed in a pop-up window.

FIG. 4 is a diagram illustrating a display example in the case where the type of an analyzing apparatus is specified in an operational status image.

FIG. 5 is a schematic configuration block diagram of an example in the case where the operational status display system for an analyzing apparatus according to the present invention is used in a client-server architecture.

FIG. 6 is a status display example of analyzing apparatuses in a conventional system.

### EXPLANATION OF NUMERALS

1 . . . Operational Status Display System For Analyzing Apparatus
2 . . . Data Communication Network
3 . . . Analyzing Apparatus Arrangement Image
4 . . . Operational Status Image
11 . . . Image Memory
12 . . . Operational Status Image Creator
13 . . . Setting Window Displayer
14 . . . Operational Status Collector
15 . . . Detailed Information Displayer
16 . . . Displaying Type Selector
18 . . . Monitor
19 . . . Input Unit
21 . . . Operational Status Notifier
301 . . . Server

### BEST MODES FOR CARRYING OUT THE INVENTION

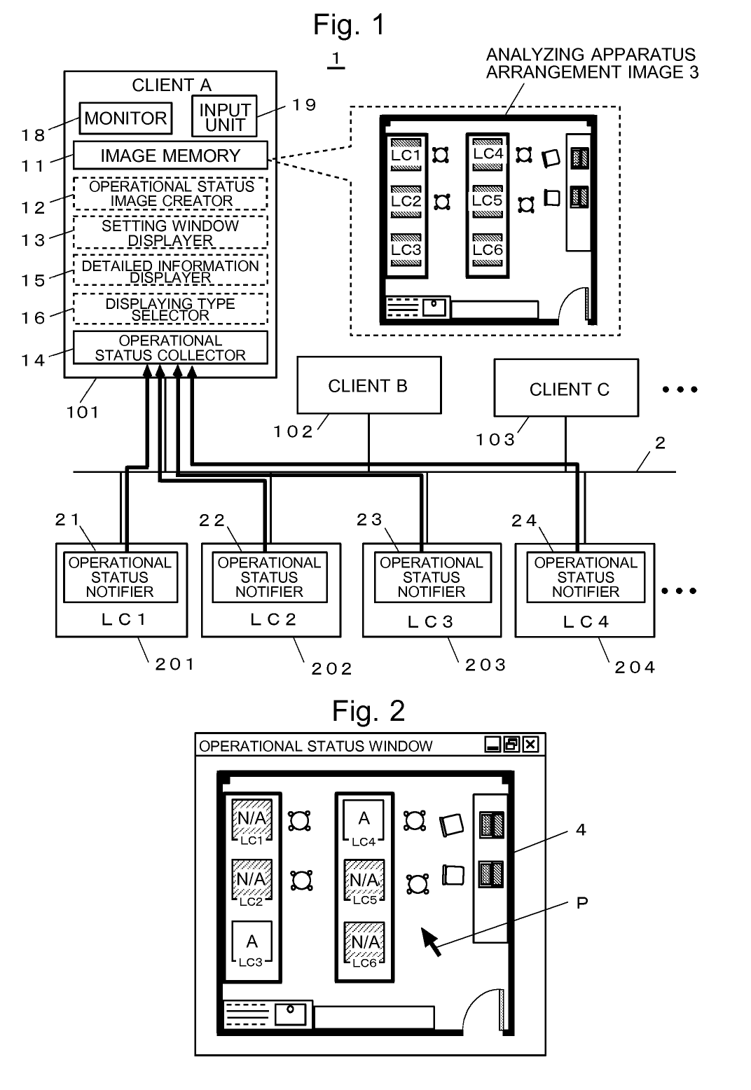

FIG. 1 is a block diagram illustrating a schematic configuration of an embodiment of the operational status display system for an analyzing apparatus according to the present invention. The system 1 according to the present embodiment includes a client for analysis A101, client B102, . . . , and a plurality of analyzing apparatuses 201, 202, . . . , which are connected to a data communication network 2 such as a local area network (LAN). Although only four analyzing apparatuses are illustrated in FIG. 1, the following explanation supposes that six analyzing apparatuses are connected to the network.

The clients 101, 102, . . . are normally a PC which includes a storage media such as a hard disk in which programs and data are stored in advance, a monitor 18 such as a cathode ray tube (CRT) display or a liquid crystal display, and an input unit 19 such as a keyboard having character and number input keys, various function keys, and other keys, and a mouse which is a pointing device, other than a central processing unit (CPU) and a memory (random access memory: RAM) which are not illustrated. In the PC, these units are connected each other. The storage media has an image memory 11 as its portion. The image memory 11 stores an analyzing apparatus arrangement image 3 which illustrates the arrangement positions of a plurality of mutually-discriminable apparatuses corresponding one-to-one to the analyzing apparatuses.

The analyzing apparatus arrangement image 3 is image data such as a bitmapped image and a vector image which are prepared in advance by the user, and expresses the arrangement positions of the actual analyzing apparatuses in a plain view form or the like.

In the example illustrated in FIG. 1, a plain view of a room is stored as the analyzing apparatus arrangement image 3 in the image memory 11. In the analyzing apparatus arrangement image 3, apparatus images which correspond one-to-one to LC1, LC2, . . . , LC6 which are an analyzing apparatus are arranged. The apparatus image can be simple enough to present an analyzing apparatus in a frame format or a simplified format. Although the apparatus image is not required to reflect the actual analyzing apparatus' shape and size, it is required to present what apparatus image corresponds to what analyzing apparatus. For example, the analyzing apparatus' name may be displayed on each apparatus image or near the apparatus image. In the analyzing apparatus arrangement image 3 illustrated in FIG. 1, each apparatus image is a roughly square image with an analyzing apparatus name, such as LC1, LC2, . . . , illustrated on it. Hence, the user can recognize at a glance what apparatus image corresponds to what analyzing apparatus when looking at this analyzing apparatus arrangement image 3.

The analyzing apparatus arrangement image 3 may preferably be illustrated in detail to the extent that the actual position of the analyzing apparatus can be easily grasped when the user looks at the image. The analyzing apparatus arrangement image 3 may also include images of objects such as a door and desk which help the user to comprehend the position of the installed analyzing apparatus.

The clients for analysis 101, . . . has an operational status image creator 12, a setting window displayer 13, and an operational status collector 14 which are functions achieved by executing a predetermined operational status display program on the CPU.

The analyzing apparatuses 201, 202, . . . respectively have operational status notifiers 21 and 22, and transmit the analyzing apparatus' operational status information on the request from the operational status collector 14 of the client 101. The operational status notifier may be installed in an analyzing apparatus, or may be a function of an external controller consisting of a computer connected to the analyzing apparatus. Although in the present embodiment the analyzing apparatus is a liquid chromatograph (LC), the analyzing apparatus may be other types of an analyzing apparatus or measuring apparatus. Plural types of analyzing and measuring apparatus may be used in the system.

In order to display an operational status image illustrating the analyzing apparatus' operational status in a client A101 in the operational status display system for an analyzing apparatus according to the present invention, apparatus image information composed of a coordinate value and coordinate data for specifying the position of each analyzing image may be included, as a preparation, in the analyzing apparatus arrangement image 3 which are drawn by using image drawing software or the like.

In the aforementioned method, the user draws the analyzing apparatus arrangement image 3 including apparatus images, and specifies the position of the apparatus image to associate the apparatus image with an analyzing apparatus. In order to simplify this operation, the operational status display system for an analyzing apparatus according to the present invention may include a function to support the creation of the analyzing apparatus arrangement image 3. With this function, for example, the user places apparatus images which are an icon previously linked to each analyzing apparatus on an original analyzing apparatus arrangement image in which no apparatus image is illustrated to create the analyzing apparatus arrangement image 3 including the apparatus image information.

Next, when the operational status display program is manually (in response to a user operation) or automatically launched on the client A101, the operational status collector 14 transmits an information access request to all the analyzing apparatuses 201, 202, . . . . The operational status notifiers 21, 22, . . . which have received this request transmit the analyzing apparatus' operational status information to the operational status collector 14 of the client A101.

The analyzing apparatus' operational status includes status information of an analysis which is automatically progressed in each analyzing apparatus in accordance with an analysis schedule table in which an analysis procedure is specified. The status information may be, for example, “ready before execution”, “in execution”, “finished”, “error”, or other status information. The apparatus' operational status may further include information for identifying the person in charge of the analysis, estimated completion time of the analysis or other information.

The operational status collector 14 collects and integrates the operational status information of each analyzing apparatus at predetermined time intervals to maintain the freshness of the operational status information. Alternatively, new operational status information may be transmitted from an analyzing apparatus to the operational status collector 14 every time the analyzing apparatus' operational status changes.

The operational status image creator 12 reads out the analyzing apparatus arrangement image 3 from the image memory 11 and refers to the apparatus image information. Based on each analyzing apparatus' operational status information collected by the operational status collector 14, the operational status image creator 12 displays the operational status of the corresponding analyzing apparatus as character data or image data on each apparatus image on the analyzing apparatus arrangement image 3 to create the operational status image 4. “On an apparatus image” in the present invention is not limited to “directly on an apparatus image” but may be “in the vicinity of an apparatus image.”

The operational status image 4 thus created is displayed on the monitor 18 (FIG. 2). The operational status image creator 12 re-creates at a predetermined timing the new operational status image 4 so that the information displayed on the operational status image 4 should be updated. The timing may be the point in time when the operational status information of each analyzing apparatus which the operational status collector 14 collects is updated or may be every predetermined update time.

The analyzing apparatus' operational status which can be displayed on the apparatus image in the analyzing apparatus arrangement image 3 includes, for example, the availability of the apparatus and the name of the user who is currently using the analyzing apparatus. In addition, the color or shape of the apparatus image may be changed in accordance with the analyzing apparatus' operational status. For example, “N/A” (not available) may be displayed on an apparatus image corresponding to an unavailable analyzing apparatus and the brightness of the apparatus image may be lowered at the same time. In the operational status image 4 in FIG. 2, a character of “A” (available) is displayed on the apparatus images corresponding to the available analyzing apparatuses. On the other hand, regarding the apparatus images corresponding to the unavailable analyzing apparatuses, hatched lines are drawn on them and a character of “N/A” is displayed thereon.

In the operational status image 4 displayed on the monitor 18, when the user moves a specifier (mouse pointer) P to put it on either of the apparatus images and performs an input operation such as a double click, the setting window displayer 13 which has received the input displays a setting window for the analyzing apparatus corresponding to the apparatus image. Hence, the user can directly move on to the detailed setting operation for an analyzing apparatus from the status where the operational status image 4 is displayed.

In addition, a window relating to an analyzing apparatus other than a setting window for an analyzing apparatus may be displayed from the display window of the operational status image 4. For example, in response to a right click with the mouse pointer P being placed on an apparatus image, a context menu for allowing the user to select an information display of a data file or the like according to the analyzing apparatus may be displayed.

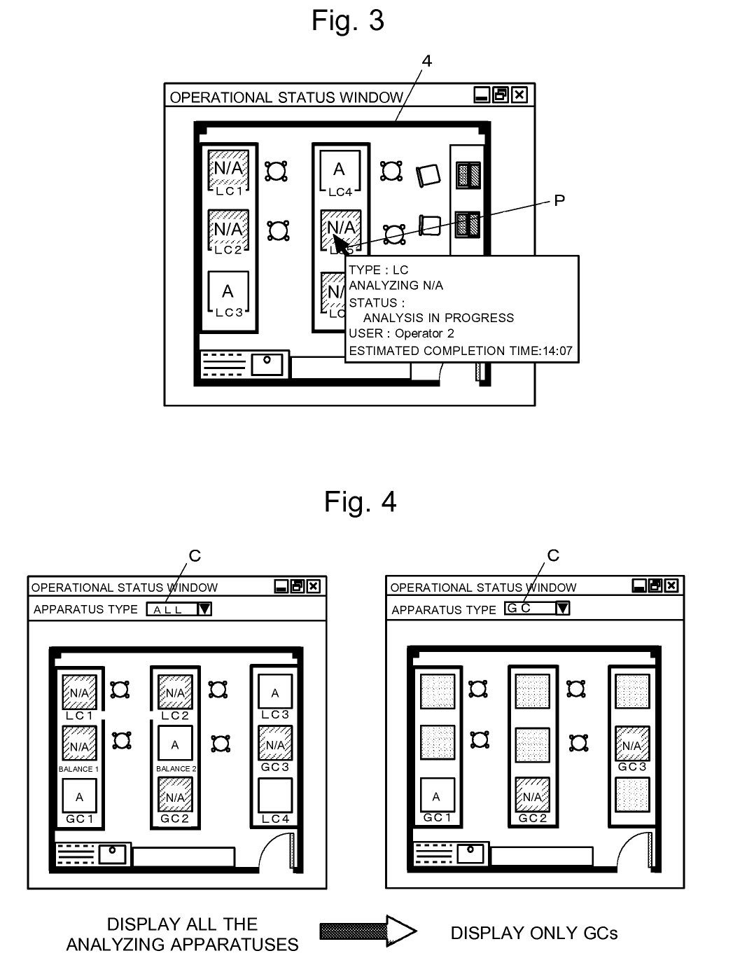

Generally, the operational status of an analyzing apparatus displayed in the operational status image 4 is only a partial piece of information included in the analyzing apparatus' operational status, such as “A” and “N/A.” Although a setting window can be immediately displayed by entering a predetermined instruction input as described earlier, this might be bothersome since in this case a setting window is displayed each time. Hence, it is preferable that the system according to the present invention may further have a detailed information displayer 15. The detailed information displayer 15 detects that the mouse pointer P is overlapped on an apparatus image, and displays, as illustrated in FIG. 3, detailed information composed of a part of or all of the operational status of the analyzing apparatus corresponding to the apparatus image in a popup window. Alternatively, the detailed information may be displayed on a predetermined position in the window.

In the case where many kinds of analyzing apparatuses are connected to the system 1, it is user-friendly to relatively highlight only a specified kind of analyzing apparatus to other kinds of analyzing apparatuses in the operational status image 4. Hence, it is preferable that the operational status display system for an analyzing apparatus according to the present invention may further have a displaying type selector 16 in the client 101, 102, . . . . In this configuration, as illustrated in FIG. 4, a selector such as a combo box C for allowing the user to select an apparatus type is provided in a portion of the window in which the operational status image 4 is displayed.

In the left window of FIG. 4, “ALL” is selected as the apparatus type and all kinds of analyzing apparatuses are displayed. In this example, three kinds of analyzing apparatuses of LC, GC, BALANCE are installed. In the case where the user selects the apparatus type “GC” by using the input unit 19, the displaying type selector 16 changes, based on the entered indication, the apparatus images whose kind is other than GC into grayout in the operational status image 4, as illustrated in the right window of FIG. 4. That is, only apparatus images in accordance with GC are activated and displayed, which accordingly makes them relatively highlighted. Although neither apparatus names such as “LC1” are displayed on the analyzing apparatuses whose kind is other than GC in the present example, the apparatus name can be displayed in the operational status image 4 as a matter of course.

In addition, the displaying type selector 16 may only change the apparatus image's display mode. In this case, a setting window for the corresponding analyzing apparatus may be displayed as usual in response to a click of an analyzing image. Alternatively, detailed information may be displayed when the mouse pointer P is placed over the apparatus image.

As described thus far, the operational status display system for an analyzing apparatus according to the present invention has been explained using some examples. It should be noted that these are merely examples, and any modification and improvement can be properly made within the spirit of the present invention.

In the aforementioned example, each client integrates the operational status information of the analyzing apparatuses. However, the operational status of all the analyzing apparatuses may be collected and integrated by an integration server or the like provided in addition to the clients on the network, and the integrated operational status may be transmitted to the operational status collector 14 of each client.

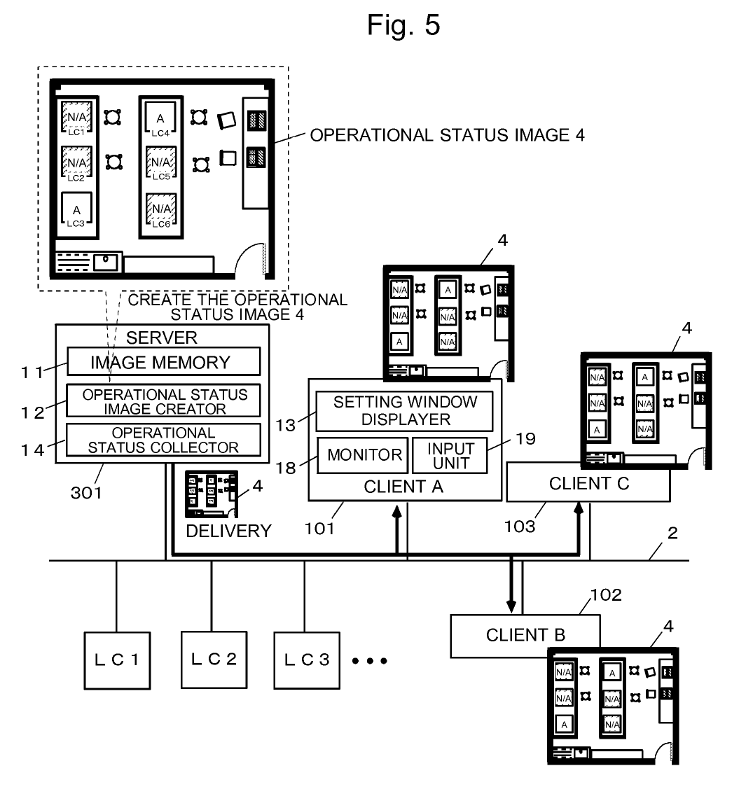

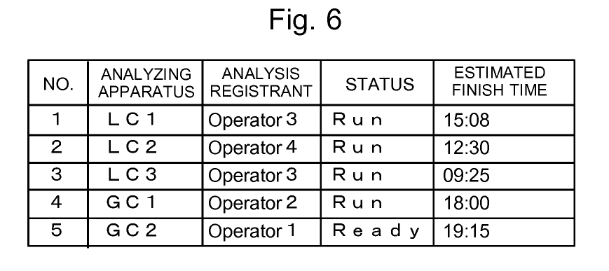

As a modified example, the operational status display system for an analyzing apparatus according to the present invention may be configured as a client-server architecture (FIG. 5). The system of this configuration is realized by a server 301 and each of the clients for analysis A101, B102, and C103, each executing a predetermined operational status display program for an analyzing apparatus.

In this configuration, the operational status image 4 is created and managed on the side of the server in an integrated manner by providing the image memory 11 and the operational status image creator 12 in the server 301. That is, the operational status image creator 12 of the server 301 creates, every time an operational status is updated, the operational status image 4, and transmits it to the clients for analysis A101, 102, 103, . . . . In the client for analysis A101, the operational status image 4 received is displayed on the monitor 18. With the setting window displayer 13 provided in the computer of a client for analysis, when an apparatus image is clicked in a window in which the operational status image 4 on the monitor 18 is displayed, it is possible to open the setting window of the corresponding analyzing apparatus. The setting window's information may be directly received from each analyzing apparatus or may be received from the server.

With the configuration as described earlier, the analyzing apparatus arrangement image 3 may be stored only in the image memory 11 of the server 301 and it is not necessary to configure the setting for each client for analysis. In addition, in the case where the arrangement of the analyzing apparatuses is changed, making a change only to the analyzing apparatus arrangement image 3 stored in the image memory 11 of the server 301 will have an effect on all the clients for analysis.

The operational status image creator 12 and the operational status collector 14 may be provided not on a server but on the side of a client for analysis. In this case, only the image memory 11 is provided in the server 301 and the analyzing apparatus arrangement image 3 is delivered to each client for analysis at a point in time when a client for analysis is booted for example. With this configuration, it is possible to manage and store the analyzing apparatus arrangement image 3 in an integrated manner.

In a client-sever architecture as previously described, in order to prevent the change and alteration of the analyzing apparatus arrangement image 3 due to a careless or malicious operation by a user or other persons, it is preferable to set that only a specified user, i.e. only the user who has logged in with specific identification data (ID) and a password, can change the analyzing apparatus arrangement image 3 stored in the image memory 11 of the server 301.

1. An operational status display system for an analyzing apparatus, including a plurality of analyzing apparatuses and a client for analysis which has an operational status collector for collecting an operational status of an analyzing apparatus through a data communication network, wherein the client for analysis comprises:
a) an image memory for storing an analyzing apparatus arrangement image in which a plurality of mutually-discriminable apparatus images corresponding one-to-one to the analyzing apparatuses are arranged in order to present an actual arrangement position of the analyzing apparatuses.

2. The operational status display system for an analyzing apparatus according to claim 1, wherein the client for analysis further comprises:
b) an operational status image creator for creating, at a predetermined timing, an operational status image in which an operational status of a corresponding analyzing apparatus is displayed on each apparatus image in the analyzing apparatus arrangement image.

3. The operational status display system for an analyzing apparatus according to claim 2, wherein the client for analysis further comprises:
c) a setting window displayer for displaying, based on an entry of a predetermined input operation with a specifier being placed on an apparatus image, a setting window for an analyzing apparatus corresponding to the apparatus image in a window for the operational status image.

4. The operational status display system for an analyzing apparatus according to claim 2, wherein the client for analysis further comprises:
d) a detailed information displayer for displaying, when the a specifier is overlapped on an apparatus image in a window for the operational status image, detailed information of an operational status of a corresponding analyzing apparatus in a pop-up window or at a predetermined position of the window for the operational status image.

5. The operational status display system for an analyzing apparatus according to claim 2, wherein the client for analysis further comprises:
e) a displaying type selector for relatively highlighting, based on an analyzing apparatus type specifying instruction entered by a user, an apparatus image corresponding to an analyzing apparatus of a type specified.

6. The operational status display system for an analyzing apparatus according to claim 2, further including a server capable of communicating with the client for analysis through the data communication network, wherein:
the server includes the image memory; and
the operational status image creator of the client uses an analyzing apparatus arrangement image stored in the image memory.

7. The operational status display system for an analyzing apparatus according to claim 2, further including a server capable of communicating with the client for analysis through the data communication network, wherein:
the server includes the mage memory and the operational status image creator; and
the client displays the operational status image created at a predetermined timing by the operational status image creator.

8. The operational status display system for an analyzing apparatus according to claim 3, wherein the client for analysis further comprises:
d) a detailed information displayer for displaying, when the specifier is overlapped on an apparatus image in the window for the operational status image, detailed information of an operational status of a corresponding analyzing apparatus in a pop-up window or at a predetermined position of the window for the operational status image.

9. The operational status display system for an analyzing apparatus according to claim 3, wherein the client for analysis further comprises:
e) a displaying type selector for relatively highlighting, based on an analyzing apparatus type specifying instruction entered by a user, an apparatus image corresponding to an analyzing apparatus of a type specified.

10. The operational status display system for an analyzing apparatus according to claim 4, wherein the client for analysis further comprises:
e) a displaying type selector for relatively highlighting, based on an analyzing apparatus type specifying instruction entered by a user, an apparatus image corresponding to an analyzing apparatus of a type specified.

11. The operational status display system for an analyzing apparatus according to claim 3, further including a server capable of communicating with the client for analysis through the data communication network, wherein:
the server includes the image memory; and
the operational status image creator of the client uses an analyzing apparatus arrangement image stored in the image memory.

12. The operational status display system for an analyzing apparatus according to claim 4, further including a server capable of communicating with the client for analysis through the data communication network, wherein:
the server includes the image memory; and
the operational status image creator of the client uses an analyzing apparatus arrangement image stored in the image memory.

13. The operational status display system for an analyzing apparatus according to claim 5, further including a server capable of communicating with the client for analysis through the data communication network, wherein:
the server includes the image memory; and
the operational status image creator of the client uses an analyzing apparatus arrangement image stored in the image memory.

14. The operational status display system for an analyzing apparatus according to claim 3, further including a server capable of communicating with the client for analysis through the data communication network, wherein:
the server includes the mage memory and the operational status image creator; and
the client displays the operational status image created at a predetermined timing by the operational status image creator.

15. The operational status display system for an analyzing apparatus according to claim 4, further including a server capable of communicating with the client for analysis through the data communication network, wherein:
the server includes the mage memory and the operational status image creator; and
the client displays the operational status image created at a predetermined timing by the operational status image creator.

16. The operational status display system for an analyzing apparatus according to claim 5, further including a server capable of communicating with the client for analysis through the data communication network, wherein:
the server includes the mage memory and the operational status image creator; and
the client displays the operational status image created at a predetermined timing by the operational status image creator.
